(19) United States
(12) Patent Application Publication
(10) Pub. No.: US 2024/0421766 A1
(43) Pub. Date: Dec. 19, 2024

(54) PHOTOVOLTAIC INVERTER AND TEMPERATURE DETECTION APPARATUS

(71) Applicant: Huawei Digital Power Technologies Co., Ltd., Shenzhen (CN)

(72) Inventors: Xu HE, Xi'an (CN); Fangpo ZHANG, Shanghai (CN)

(73) Assignee: Huawei Digital Power Technologies Co., Ltd., Shenzhen (CN)

(21) Appl. No.: 18/814,649

(22) Filed: Aug. 26, 2024

Related U.S. Application Data
(63) Continuation of application No. PCT/CN2023/103480, filed on Jun. 28, 2023.

(30) Foreign Application Priority Data
Nov. 30, 2022 (CN) 202211527833.4

(51) Int. Cl. H02S 50/10; H02S 40/32; H02S 40/40

(52) U.S. Cl. CPC H02S 50/10; H02S 40/32; H02S 40/40

(57) ABSTRACT

A photovoltaic inverter and a temperature detection apparatus. The photovoltaic inverter includes a plurality of photovoltaic terminals, a converter, a printed circuit board (PCB), a temperature detection circuit, and a controller. The plurality of photovoltaic terminals are correspondingly connected to a plurality of photovoltaic modules. The PCB includes an electrically conductive layer and at least one thermally conductive insulation layer. One end of each photovoltaic terminal is soldered on the PCB, and the other end is connected to a corresponding photovoltaic module in a thermally conductive manner. The electrically conductive layer transmits electric energy generated by the plurality of photovoltaic modules to the converter. Each thermally conductive insulation layer conducts heat generated by at least one photovoltaic terminal. The temperature detection circuit detects a temperature of each thermally conductive insulation layer.

### CROSS-REFERENCE TO RELATED APPLICATIONS

This application is a continuation of International Patent Application No. PCT/CN2023/103480, filed on Jun. 28, 2023, which claims priority to Chinese Patent Application No. 202211527833.4, filed on Nov. 30, 2022. The disclosures of the aforementioned applications are hereby incorporated by reference in their entireties.

### TECHNICAL FIELD

The embodiments relate to the field of photovoltaic power generation and to a photovoltaic inverter and a temperature detection apparatus.

### BACKGROUND

Photovoltaic power generation is a technology of converting light energy into electric energy by using a photovoltaic effect of a semiconductor interface. A photovoltaic system may include a photovoltaic module, a photovoltaic terminal, an inverter, an alternating current power distribution device, and the like. The photovoltaic module can be mounted on a photovoltaic rack that is fixedly supported on the ground, to generate power in a fixed place. To obtain a high output voltage or output current, a photovoltaic unit can be a photovoltaic string formed by connecting a plurality of photovoltaic modules in series and/or parallel.

Currently, each photovoltaic module is connected to a photovoltaic inverter or a photovoltaic direct current combiner box by using a photovoltaic terminal (also referred to as a connector). A photovoltaic terminal transmits, through a reliable electrical connection, a current output by a photovoltaic module to the inside of the photovoltaic inverter or the photovoltaic direct current combiner box, to implement current inversion, so that electric energy enters a terminal user or is connected to a power grid. An existing wiring process of a photovoltaic terminal is: stripping a cable, and then using a cable-specific tool to separately crimp the stripped parts of the cable on two sides of the photovoltaic terminal, where one side of the cable is connected to a photovoltaic module, and the other side of the cable is connected to a photovoltaic inverter or a photovoltaic direct current combiner box. When the photovoltaic terminal and the cable are poorly crimped, excessively large contact resistance is likely to occur, causing heating and even aging and fire.

Currently, there is no implementation solution for detecting a temperature of a photovoltaic terminal connected between a photovoltaic module and an inverter. In view of this, a photovoltaic inverter needs to be designed, to monitor an actual temperature of the photovoltaic terminal in real time before the photovoltaic terminal catches fire, to ensure reliability of power generation of an entire system.

### SUMMARY

The embodiments provide a photovoltaic inverter and a temperature detection apparatus. A temperature of a photovoltaic terminal is detected by using a temperature detection circuit, to monitor an actual temperature of the photovoltaic terminal in real time before the photovoltaic terminal catches fire, to ensure reliability of power generation of the entire photovoltaic inverter.

According to a first aspect, the embodiments provide a photovoltaic inverter. The photovoltaic inverter includes: a plurality of photovoltaic terminals, a converter, a printed circuit board (PCB), a temperature detection circuit, and a controller. A plurality of photovoltaic modules are configured to be correspondingly connected to the plurality of photovoltaic terminals. The PCB includes an electrically conductive layer and at least one thermally conductive insulation layer. One end of each photovoltaic terminal is soldered on the PCB, and the other end is connected to a corresponding photovoltaic module in a thermally conductive manner. The electrically conductive layer is configured to transmit electric energy generated by each photovoltaic module to the converter. Each thermally conductive insulation layer is configured to conduct heat generated by at least one photovoltaic terminal. The temperature detection circuit is configured to detect a temperature of each thermally conductive insulation layer. The controller is configured to obtain a temperature of each of the plurality of photovoltaic terminals based on the temperature of each thermally conductive insulation layer.

The photovoltaic inverter provided in the embodiments is used so that heat generated by each photovoltaic terminal can be conducted by using the at least one thermally conductive insulation layer, and the heat can be conducted to the temperature detection circuit; and the temperature of each of the plurality of photovoltaic terminals is obtained by detecting the temperature of each thermally conductive insulation layer, to avoid a problem of aging, over-temperature, and fire caused by poor crimping of the photovoltaic terminals.

In a possible implementation, between each photovoltaic terminal and the temperature detection circuit, the PCB includes a thermally conductive path including the thermally conductive insulation layer and solder joints, at which the plurality of photovoltaic terminals are connected to the PCB. Each photovoltaic terminal is soldered to the PCB to form a plurality of solder joints, and each thermally conductive insulation layer is configured to be connected to at least one solder joint, to form the thermally conductive path including the thermally conductive insulation layer and the solder joints, formed between the photovoltaic terminals and the PCB, so that the temperature detection circuit determines the temperature of each photovoltaic terminal by detecting different thermally conductive insulation layers. With this implementation, a quantity of temperature detection circuits can be significantly reduced, and temperature detection costs are reduced. Each thermally conductive insulation layer includes a thermally conductive material, and the thermally conductive material is coated with an insulation material.

In a possible implementation, the thermally conductive material includes one or more of graphite, copper foil, or aluminum foil, and the insulation material includes one or more of epoxy resin, silicone rubber, insulation ceramic, or glass.

In a possible implementation, the thermally conductive material forms a thermally conductive layer, the insulation material forms an insulation layer, an upper surface and a lower surface of the thermally conductive layer are separately laminated with the insulation layer to form the thermally conductive insulation layer, and the insulation layer coats and is attached to the laminated thermally conductive layer.

Because the plurality of photovoltaic terminals and the converter are respectively disposed on two sides of the PCB, if only one temperature detection circuit is disposed, the temperature detection circuit is easily affected by an external ambient temperature, causing an error in temperature detection. In a possible implementation, the temperature detection circuit includes a first temperature detection circuit and a second temperature detection circuit. The plurality of photovoltaic terminals and the converter are disposed on two sides of the PCB. The PCB includes a first thermally conductive insulation layer and a second thermally conductive insulation layer, the first thermally conductive insulation layer is close to a side of the converter, and the second thermally conductive insulation layer is close to a side of the photovoltaic terminals. The first temperature detection circuit is configured to detect a temperature of the first thermally conductive insulation layer. The second temperature detection circuit is configured to detect a temperature of the second thermally conductive insulation layer. The controller is configured to obtain the temperature of each of the plurality of photovoltaic terminals based on the temperatures of the first thermally conductive insulation layer and the second thermally conductive insulation layer.

A thermally conductive path between the photovoltaic terminal and the first temperature detection circuit or the second temperature detection circuit may be: the photovoltaic terminal (plug-in point)—the solder joints formed between the photovoltaic terminal and the PCB—the first temperature detection circuit or the second temperature detection circuit. With this implementation, an overall design of the temperature detection circuit is simple and possible, temperature detection is performed by using the first temperature detection circuit and the second temperature detection circuit, and temperature detection is more accurate.

In a possible implementation, the photovoltaic inverter further includes: a housing structure and a mounting panel. The housing structure is provided with a notch. The converter is disposed inside the housing structure. The mounting panel is provided with through holes for the photovoltaic terminals to penetrate. The mounting panel is configured to be mounted on the housing structure and plug the notch.

During specific mounting, the housing structure and the mounting panel may be fastened through soldering or bonding or by using a screw. Alternatively, in some possible implementations, the housing structure and the mounting panel may be an integrated structure. Before the plurality of photovoltaic terminals are soldered on the PCB, the plurality of photovoltaic terminals may be first fastened to the mounting panel, to position arrangement positions of the plurality of photovoltaic terminals, to facilitate soldering between the photovoltaic terminals and the PCB. After the photovoltaic terminals and the PCB are soldered, an overall structure including the photovoltaic terminals, the PCB, and the mounting panel is mounted in the notch of the housing structure.

In a possible implementation, sealants or baffle plates are disposed in gaps between the photovoltaic terminals and the through holes, so that a sealed environment is formed inside the housing structure. Because there is a cooling device, such as a fan, inside the housing structure to reduce impact of the fan on temperature detection of the PCB and the temperature detection circuit, the sealants or the baffle plates are disposed in the gaps between the photovoltaic terminals and the through holes, so that the sealed environment is formed inside the housing structure.

In a possible implementation, each photovoltaic terminal includes a board-end terminal, a cable-end terminal, a first electrically conductive core, a second electrically conductive core, a first electrically conductive cable, and a second electrically conductive cable. A channel that penetrates through two ends of the board-end terminal is provided in the board-end terminal, the first electrically conductive core is slidably disposed in the channel of the board-end terminal, one end of the first electrically conductive cable is crimped on the first electrically conductive core, and the other end of the first electrically conductive cable is soldered on the PCB. A channel that penetrates through two ends of the cable-end terminal is provided in the cable-end terminal, the second electrically conductive core is slidably disposed in the channel of the cable-end terminal, one end of the second electrically conductive cable is crimped on the second electrically conductive core, and the other end of the second electrically conductive cable is connected to the photovoltaic module. After the board-end terminal is connected to the cable-end terminal, the first electrically conductive core establishes an electrical connection to the second electrically conductive core, so that a current output by the photovoltaic module is input to the converter by using the photovoltaic terminal.

To reduce a heat loss on the thermally conductive path, in a possible implementation, the photovoltaic inverter further includes: a terminal plug-in temperature detection circuit. The terminal plug-in temperature detection circuit is disposed at a position where the board-end terminal and the cable-end terminal in the photovoltaic terminal are connected, and is configured to detect the temperature of the photovoltaic terminal.

The terminal plug-in temperature detection circuit is adjacent to a photovoltaic terminal. This can greatly reduce the heat loss on a conduction path and can reflect the temperature of the photovoltaic terminal to a maximum extent, to make temperature protection more accurate. The terminal plug-in temperature detection circuit is disposed at a position where the board-end terminal and the cable-end terminal in the corresponding photovoltaic terminal are connected, to detect the temperature of the photovoltaic terminal.

In addition, in a possible implementation, when the temperature detection circuit is disposed on the PCB, the temperature detection circuit should be disposed at a position as far from a circuit with a large through-current as possible, to reduce a temperature detection error caused by heating due to thermal effect.

If the temperature detection circuit has to be disposed at the circuit with a large through-current, self-heating on the PCB may also be reduced by adding a groove or a protrusion on the circuit, and through-current heating may be reduced by increasing a width of an electrically conductive material at a position with a large through-current.

According to a second aspect, the embodiments provide a temperature detection apparatus, applied to a photovoltaic inverter. The temperature detection apparatus includes a temperature detection circuit, a PCB, and a controller. The photovoltaic inverter includes a plurality of photovoltaic terminals and a converter. The plurality of photovoltaic terminals are configured to be correspondingly connected to a plurality of photovoltaic modules. The PCB includes an electrically conductive layer and at least one thermally conductive insulation layer. One end of each photovoltaic terminal is soldered to the PCB, and the other end is connected to a corresponding photovoltaic module in a thermally conductive manner. The electrically conductive layer is configured to transmit electric energy generated by each photovoltaic module to the converter. Each thermally conductive insulation layer is configured to conduct heat generated by at least one photovoltaic terminal. The temperature detection circuit is configured to detect a temperature of each thermally conductive insulation layer.

These or other aspects of the embodiments are more concise and easier to understand in the following descriptions.

### BRIEF DESCRIPTION OF DRAWINGS

FIG. 1 is a diagram 1 of a structure of a photovoltaic inverter;

FIG. 2 is a diagram of a thermally conductive path between a photovoltaic terminal and a temperature detection circuit;

FIG. 3 is a diagram 2 of a structure of a photovoltaic inverter;

FIG. 4 is a diagram of a structure of a housing structure;

FIG. 5 is a diagram 1 of a structure of a photovoltaic terminal; and

FIG. 6 is a diagram 2 of a structure of a photovoltaic terminal.

### DETAILED DESCRIPTION OF EMBODIMENTS

To make objectives, solutions, and advantages of the embodiments clearer, the following further describes the embodiments in detail with reference to the accompanying drawings. However, example implementations may be implemented in a plurality of forms and should not be construed as being limited to implementations described herein. On the contrary, these implementations are provided such that the embodiments are more comprehensive and complete and fully convey the concept of the example implementations to a person skilled in the art. Identical reference numerals in the accompanying drawings denote identical or similar structures. Therefore, repeated description thereof is omitted. Expressions of positions and directions in the embodiments are described by using the accompanying drawings as an example. However, changes may also be made as required, and all the changes fall within the scope of the embodiments. The accompanying drawings are merely used to illustrate relative position relationships and do not represent an actual scale.

To make objectives, solutions, and advantages of the embodiments clearer, the following further describes the embodiments in detail with reference to the accompanying drawings. A specific operation method in a method embodiment may also be applied to an apparatus embodiment or a system embodiment. It should be noted that, in descriptions of the embodiments, “at least one” means one or more, and “a plurality of” means two or more. In view of this, in embodiments, “a plurality of” may also be understood as “at least two”. The term “and/or” describes an association relationship between associated objects and indicates that three relationships may exist. For example, A and/or B may represent the following three cases: only A exists, both A and B exist, and only B exists. In addition, the character “/”, unless otherwise specified, generally indicates an “or” relationship between the associated objects. In addition, it should be understood that in description of the embodiments, terms such as “first” and “second” are merely used for distinguishing and description, but should not be understood as indicating or implying relative importance, or should not be understood as indicating or implying a sequence.

It should be noted that, in embodiments, “connection” means an electrical connection, and a connection between two electrical elements may be a direct or indirect connection between the two electrical elements. For example, a connection between A and B may be a direct connection between A and B, or may be an indirect connection between A and B through one or more other electrical elements. For example, the connection between A and B may also represent that A is directly connected to C, C is directly connected to B, A and B are connected through C.

In a photovoltaic system, a direct current source is generally formed by a photovoltaic module on a direct current side. The photovoltaic module is connected to a direct current combiner box by using a photovoltaic terminal. Currents of module strings are converged by using the direct current combiner box and connected to a converter. The converter converts a direct current generated by the photovoltaic module into an alternative current, and the alternating current is connected to a power grid to complete a photovoltaic power generation process.

With an increasingly wide application of photovoltaic power generation, an increasing number of problems of the photovoltaic system are exposed to people, and a serious problem is a fire problem caused by the photovoltaic system, which may cause huge human body and property losses.

There are many reasons for a fire of the photovoltaic system, for example, a fire caused by hot spot effect generated by the photovoltaic module. The hot spot effect is as follows: when a photovoltaic module in a series branch is shaded, the photovoltaic module is considered as a load consuming energy generated by another illuminated photovoltaic module. As a result, the shaded photovoltaic module heats up. Consequently, a local current and a local voltage of the photovoltaic module increase, and a local temperature rise occurs on the photovoltaic module. This causes spontaneous combustion of the photovoltaic module.

For another example, when a cable connected to the photovoltaic terminal is poorly crimped, excessively large contact resistance is likely to occur, causing heating of a direct current arc and even aging and fire; or when a cable connected to the photovoltaic terminal is soldered to the converter or the photovoltaic module, if an area of a solder joint is excessively small, resistance is also increased, to cause a fire.

Currently, there are some temperature detection and protection solutions for the photovoltaic module, but no implementation solution for performing temperature detection on a photovoltaic terminal connected between the photovoltaic module and the converter is provided. In view of this, the embodiments provide a photovoltaic inverter, to monitor an actual temperature of the photovoltaic terminal in real time before the photovoltaic terminal catches fire, to ensure reliability of an entire system.

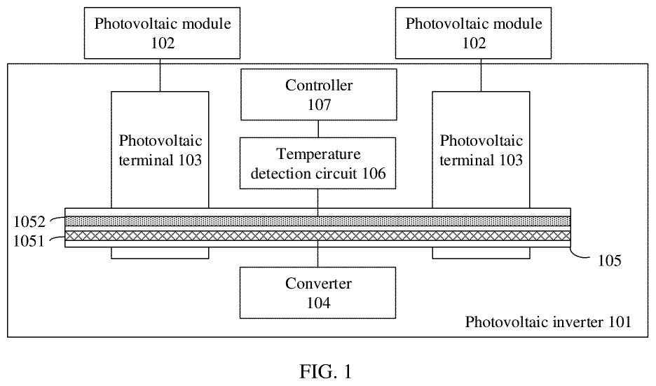

FIG. 1 is a diagram 1 of a structure of a photovoltaic inverter. The photovoltaic inverter 101 includes: a plurality of photovoltaic terminals 103, a converter 104, a printed circuit board (PCB) 105, a temperature detection circuit 106, and a controller 107. The plurality of photovoltaic terminals 103 are configured to be correspondingly connected to a plurality of photovoltaic modules 102.

The PCB 105 includes: an electrically conductive layer 1051 and at least one thermally conductive insulation layer 1052. One end of each photovoltaic terminal 103 is soldered on the PCB 105, and the other end is connected to a corresponding photovoltaic module 102 in a thermally conductive manner. The electrically conductive layer 1051 is configured to transmit electric energy generated by each photovoltaic module 102 to the converter 104. Each thermally conductive insulation layer 1052 is configured to conduct heat generated by at least one photovoltaic terminal 103.

The temperature detection circuit 106 is configured to detect a temperature of each thermally conductive insulation layer 1052. The controller 107 is configured to obtain a temperature of each of the plurality of photovoltaic terminals 103 based on the temperature of each thermally conductive insulation layer 1052.

The photovoltaic module 102 converts solar energy into electric energy by using photovoltaic effect, and the converter 104 converts the electric energy output by the photovoltaic module 102 into a proper alternating current or direct current and supplies the current to a power grid or a load.

The photovoltaic module 102 is connected to the converter 104 by using the photovoltaic terminal 103 (a connector structure). The photovoltaic terminal 103 has a small contact resistance, and has performance such as waterproof, high temperature resistance, corrosion resistance, and high insulation.

The PCB 105 may be any suitable type of PCB, for example, a multilayer board, a flexible PCB, a rigid PCB, or a rigid-flex PCB. The electrically conductive layer 1051 may be a copper busbar, an aluminum busbar, a copper-clad aluminum busbar, or a layered body made of copper and/or aluminum, or may be an electrically conductive busbar, an electrically conductive sheet, or a layered body made of another electrically conductive material. This is not limited herein.

The thermally conductive insulation layer 1052 may include an insulation layer and a thermally conductive layer (not shown in FIG. 1). A material of the insulation layer includes, but is not limited to, materials such as epoxy resin, silicone rubber, insulation ceramic, and glass, and a composite material made of any two or more of these materials. The thermally conductive layer may be one or more of graphite, copper foil, or aluminum foil, where the copper foil may be a copper clad plate (direct bonding copper, DBC), an active metal brazing copper clad plate (active metal bonding, AMB), or the like.

An upper surface and a lower surface of the thermally conductive layer are separately laminated with the insulation layer, and the insulation layer coats and is attached to the laminated thermally conductive layer, to form the thermally conductive insulation layer. The PCB 105 may further include a plurality of adhesive layers. The adhesive layers may be separately disposed between the electrically conductive layer 1051 and the thermally conductive insulation layer 1052, to bond the electrically conductive layer 1051 and the thermally conductive insulation layer 1052 together. The adhesive layers may be made of an acrylic adhesive or an epoxy resin adhesive, or may be made of another appropriate adhesive material. In addition, another auxiliary fastening element may also be provided, for example, a clamping component is provided, to fasten a plurality of different material layers in the PCB 105 together. This is not limited herein.

The temperature detection circuit 106 may include a temperature detection device such as a thermistor or an infrared temperature detection sensor. The thermistor may be any one of the following: a positive temperature coefficient (PTC) thermistor whose resistance value changes positively with a change of a temperature, or a negative temperature system (NTC) thermistor whose resistance value changes inversely with a change of a temperature. In addition, a plurality of temperature detection circuits 106 may be disposed to respectively detect temperatures of the thermally conductive insulation layers 1052.

The controller 107 may be a general-purpose central processing unit (CPU), a general-purpose processor, a digital signal processing (DSP), an application-specific integrated circuit (ASIC), a field-programmable gate array (FPGA) or another programmable logic device, a transistor logic device, a hardware component, or any combination thereof. The controller may implement or execute various example logical blocks, modules, and circuits described with reference to content in the embodiments. Alternatively, the processor may be a combination implementing a computing function, for example, a combination of one or more microprocessors, or a combination of a DSP and a microprocessor. In addition, the controller 107 may further include an analog-to-digital converter (ADC), configured to convert an input analog quantity detected by the temperature detection circuit 106 into a digital quantity, to determine the temperature of each photovoltaic terminal 103.

Two ends of the photovoltaic terminal 103 are connected to a cable, and are respectively connected to the photovoltaic module 102 and the converter 104 through the cable. For example, after the cable is stripped, the stripped parts of the cable may be separately connected to the two ends of the photovoltaic terminal 103 by using a specialized crimping tool. However, when the cable is poorly crimped to the photovoltaic terminal 103, in a least severe case, internal resistance on a direct current side is easily affected, which consequently reduces power generation efficiency of the photovoltaic inverter 101; or in a worse case, poor contact is caused and consequently causes the photovoltaic terminal 103 to be heated up or even burnt, and further causes the converter 104 to be burnt, or at worst, causes a large-scale fire.

The photovoltaic terminal 103 should be mounted in a position away from sunlight, rain, or the like, to avoid aging of an interface in the photovoltaic terminal 103 or rust of the cable. However, with development of photovoltaic technologies, a capacity of a single photovoltaic module 102 is also increasing, and an output current of the photovoltaic module 102 is also gradually increasing. In a process of mounting and using the photovoltaic terminal 103, an increasing quantity of photovoltaic terminals 103 are melted and burnt, or even burning of the converter 104 is caused. Therefore, in the embodiments, the temperature detection circuit 106 performs real-time temperature detection on the photovoltaic terminal 103, to indirectly determine a crimping status of the photovoltaic terminal 103, to ensure that the photovoltaic inverter 101 can work normally.

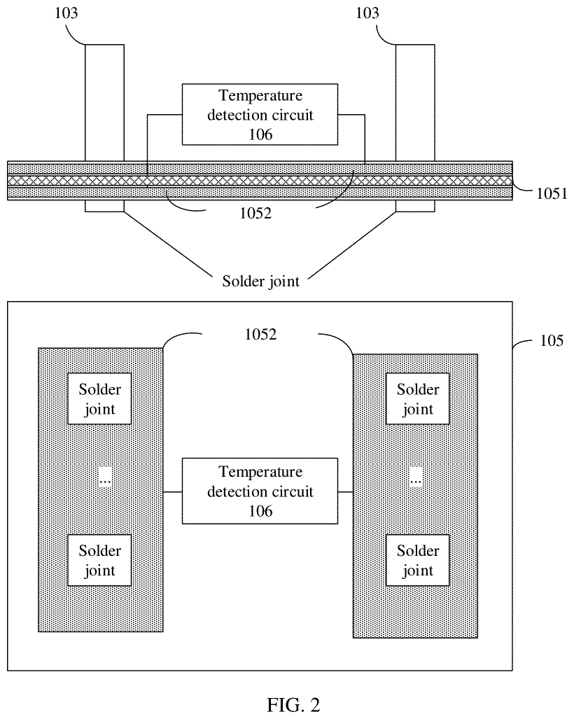

FIG. 2 is a diagram of a thermally conductive path between a photovoltaic terminal and a temperature detection circuit. Each photovoltaic terminal 103 is soldered on the PCB 105, to form a plurality of solder joints. Between each photovoltaic terminal 103 and the temperature detection circuit 106, the PCB 105 includes a thermally conductive path including a plurality of solder joints, at which the photovoltaic terminal 103 is connected to the PCB 105, and the thermally conductive insulation layer 1052, so that the temperature detection circuit 106 obtains a temperature of each photovoltaic terminal 103 by detecting different thermally conductive insulation layers 1052. With this implementation, a quantity of temperature detection circuits 106 can be significantly reduced, and temperature detection costs are reduced.

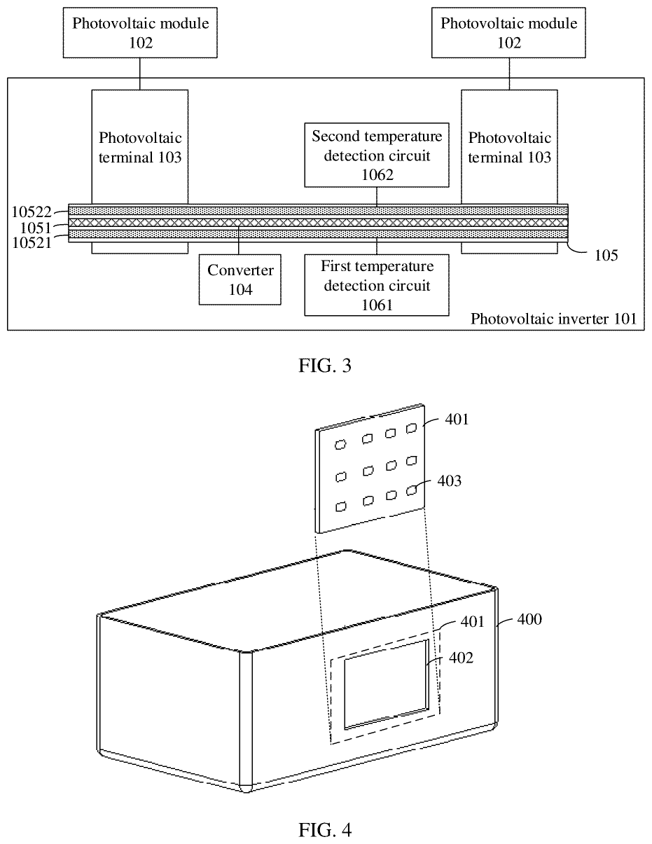

Because the plurality of photovoltaic terminals 103 and the converter 104 are respectively disposed on two sides of the PCB 105, if only one temperature detection circuit 106 is disposed, the temperature detection circuit 106 is easily affected by an external ambient temperature, causing an error in temperature detection. FIG. 3 is a diagram 2 of a structure of a photovoltaic inverter. The temperature detection circuit 106 includes a first temperature detection circuit 1061 and a second temperature detection circuit 1062. The PCB 105 includes a first thermally conductive insulation layer 10521 and a second thermally conductive insulation layer 10522. The first thermally conductive insulation layer 10521 is close to a side of the converter 104, and the second thermally conductive insulation layer 105222 is close to a side of the photovoltaic terminals 103.

The first temperature detection circuit 1061 is configured to detect a temperature of the first thermally conductive insulation layer 10521. The second temperature detection circuit 1062 is configured to detect a temperature of the second thermally conductive insulation layer 10522. The controller is configured to obtain a temperature of each of the plurality of photovoltaic terminals 103 based on the temperatures of the first thermally conductive insulation layer 10521 and the second thermally conductive insulation layer 10522.

Because a cable crimped with the photovoltaic terminal 103 is soldered on the PCB 105, the first temperature detection circuit 1061 may detect a temperature of a side on which solder joints between the photovoltaic terminal 103 and the PCB 105 are formed, and the second temperature detection circuit 1062 may detect a temperature of a side other than the side on which the solder joints between the photovoltaic terminal 103 and the PCB 105 are formed.

In this way, a thermally conductive path between the photovoltaic terminal 103 and the first temperature detection circuit 1061 or the second temperature detection circuit 1062 may be: the photovoltaic terminal 103 (plug-in point)—the solder joints formed between the photovoltaic terminal 103 and the PCB 105—the first temperature detection circuit 1061/the second temperature detection circuit 1062. With this implementation, an overall design of the temperature detection circuit 106 is simple and possible, temperature detection is performed by using the first temperature detection circuit 1061 and the second temperature detection circuit 1062, and temperature detection is more accurate.

FIG. 4 is a diagram of a structure of a housing structure. The photovoltaic inverter 101 further includes: the housing structure 400 and a mounting panel 401. The housing structure 400 is provided with a notch 402. The converter 104 is disposed inside the housing structure 400 (not shown in FIG. 4). The mounting panel 401 is provided with through holes 403 for each photovoltaic terminal 103 to penetrate. The mounting panel 401 is configured to be mounted on the housing structure 400 and block the notch 402.

During specific mounting, the housing structure 400 and the mounting panel 401 may be fastened through soldering or bonding or by using a screw. Alternatively, in some possible implementations, the housing structure 400 and the mounting panel 401 may be an integrated structure. For example, the mounting panel 401 may be molded in a manner such as die casting molding or stamping molding, to fabricate the housing structure 400 and the mounting panel 401 as an integrated mechanical part. For example, before the plurality of photovoltaic terminals 103 are soldered on the PCB 105, the plurality of photovoltaic terminals 103 may be first fastened to the mounting panel 401, to position arrangement positions of the plurality of photovoltaic terminals 103, to facilitate soldering between the photovoltaic terminals 103 and the PCB 105. After the photovoltaic terminals 103 and the PCB 105 are soldered, an overall structure including the photovoltaic terminals 103, the PCB 105, and the mounting panel 401 is mounted in the notch 402 of the housing structure 400.

Because there is a cooling device, such as a fan, inside the housing structure 400, to reduce impact of the cooling device on temperature detection of the PCB 105 and the temperature detection circuit 106, sealants or baffle plates may be disposed in gaps between the photovoltaic terminals 103 and the through holes, so that a sealed environment is formed inside the housing structure 400.

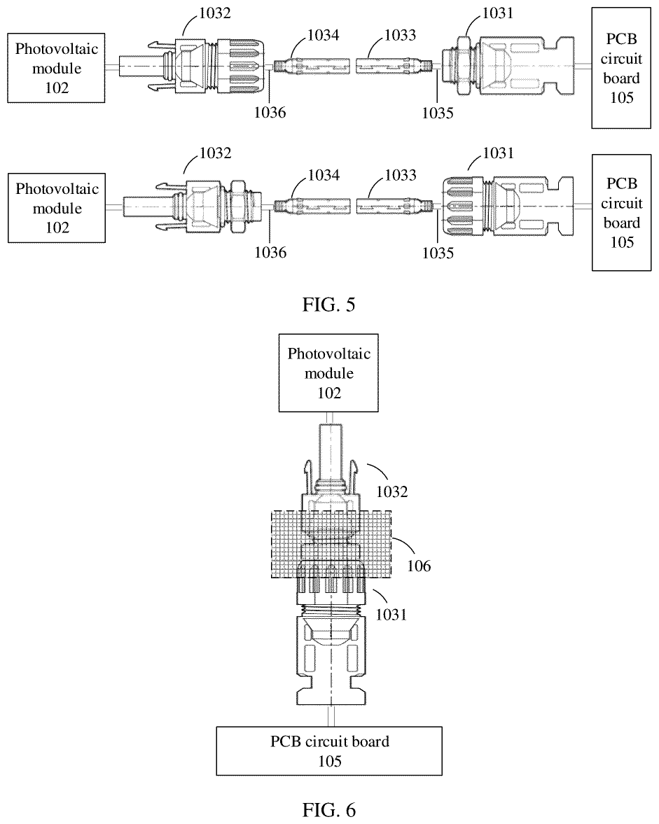

In a possible implementation, FIG. 5 is a diagram 1 of a structure of a photovoltaic terminal. Each photovoltaic terminal 103 may include a board-end terminal 1031, a cable-end terminal 1032, a first electrically conductive core 1033, a second electrically conductive core 1034, a first electrically conductive cable 1035, and a second electrically conductive cable 1036. A channel that penetrates through two ends of the board-end terminal 1031 is provided in the board-end terminal 1031, the first electrically conductive core 1033 is slidably disposed in the channel of the board-end terminal 1031, one end of the first electrically conductive cable 1035 is crimped on the first electrically conductive core 1033, and the other end of the first electrically conductive cable 1035 is soldered on the PCB 105. A channel that penetrates through two ends of the cable-end terminal 1032 is provided in the cable-end terminal 1032, the second electrically conductive core 1034 is slidably disposed in the channel of the cable-end terminal 1032, one end of the second electrically conductive cable 1036 is crimped on the second electrically conductive core 1034, and the other end of the second electrically conductive cable 1036 is connected to the photovoltaic module 102.

To reduce a heat loss on a thermally conductive path, in a possible implementation, FIG. 6 is a diagram 2 of a structure of a photovoltaic terminal. The photovoltaic inverter 101 further includes a terminal plug-in temperature detection circuit 601. The terminal plug-in temperature detection circuit 601 is disposed at a position where the board-end terminal 1031 and the cable-end terminal 1032 in the photovoltaic terminal are connected, and is configured to detect a temperature of the photovoltaic terminal 103.

The terminal plug-in temperature detection circuit 601 is adjacent to the photovoltaic terminal 103. This can greatly reduce the heat loss on a conduction path and can reflect the temperature of the photovoltaic terminal 103 to a maximum extent, to make temperature protection more accurate. The terminal plug-in temperature detection circuit 601 is disposed at the position where the board-end terminal 1031 and the cable-end terminal 1032 in the corresponding photovoltaic terminal 103 are connected, to detect the temperature of the photovoltaic terminal 103.

In addition, in a possible implementation, when the temperature detection circuit 106 is disposed on the PCB 105, the temperature detection circuit 106 should be disposed at a position as far from a circuit with a large through-current as possible, to reduce a temperature detection error caused by heating due to thermal effect.

If the temperature detection circuit 106 has to be disposed at the circuit with a large through-current, self-heating on the PCB 105 may also be reduced by adding a groove or a protrusion on the circuit, and through-current heating may be reduced by increasing a width of an electrically conductive material at a position with a large through-current.

The photovoltaic inverter provided in the embodiments is used so that heat generated by each photovoltaic terminal can be conducted by using the at least one thermally conductive insulation layer, and the heat can be conducted to the temperature detection circuit; and the temperature of each of the plurality of photovoltaic terminals is obtained by detecting the temperature of each thermally conductive insulation layer, to avoid a problem of aging, over-temperature, and fire caused by poor crimping of the photovoltaic terminals.

Based on a same idea, the embodiments further provide a temperature detection apparatus, applied to the photovoltaic inverter 101. The temperature detection apparatus includes a temperature detection circuit, a PCB, and a controller. The photovoltaic inverter includes a plurality of photovoltaic terminals and a converter. The plurality of photovoltaic terminals are configured to be correspondingly connected to a plurality of photovoltaic modules. The PCB includes an electrically conductive layer and at least one thermally conductive insulation layer. One end of each photovoltaic terminal is soldered to the PCB, and the other end is connected to a corresponding photovoltaic module in a thermally conductive manner. The electrically conductive layer is configured to transmit electric energy generated by each photovoltaic module to the converter. Each thermally conductive insulation layer is configured to conduct heat generated by at least one photovoltaic terminal. The temperature detection circuit is configured to detect a temperature of each thermally conductive insulation layer.

The foregoing descriptions are merely specific implementations of the embodiments, but are not intended as limiting. Any variation or replacement readily figured out by a person skilled in the art shall fall within the scope of the embodiments.

What is claimed is:

1. A photovoltaic inverter comprising:
a housing structure;
a printed circuit board (PCB) comprising an electrically conductive layer and a thermally conductive insulation layer;
a converter;
a plurality of photovoltaic terminals penetrating the housing structure, and having first ends inside the housing structure configured to be electrically connected to the PCB and second ends outside the housing structure configured to be connected to a plurality of photovoltaic modules, wherein the electrically conductive layer of the PCB is configured to transmit electric energy generated by the plurality of photovoltaic modules to the converter;
a temperature detection circuit configured to detect a temperature of the thermally conductive insulation layer of the PCB, wherein the thermally conductive insulation layer of the PCB is configured to conduct heat generated by the plurality of photovoltaic terminals to the temperature detection circuit;
a housing structure; and
a controller configured to detect a temperature of at least one of the plurality of photovoltaic terminals based on the temperature of the thermally conductive insulation layer of the PCB, wherein the converter and the PCB are disposed inside the housing structure.

2. The photovoltaic inverter according to claim 1, wherein, between one of the plurality of photovoltaic terminals and the temperature detection circuit, the PCB comprises a thermally conductive path including the thermally conductive insulation layer and a connection joint, at which the one of the plurality of photovoltaic terminals is connected to the PCB.

3. The photovoltaic inverter according to claim 1, wherein each thermally conductive insulation layer comprises a thermally conductive material and is coated with an insulation material.

4. The photovoltaic inverter according to claim 3, wherein the thermally conductive material comprises one or more of graphite, copper foil, or aluminum foil.

5. The photovoltaic inverter according to claim 3, wherein the insulation material comprises one or more of epoxy resin, silicone rubber, insulation ceramic, or glass.

6. The photovoltaic inverter according to claim 3, wherein the thermally conductive material forms a thermally conductive layer, the insulation material forms an insulation layer.

7. The photovoltaic inverter according to claim 1, wherein the temperature detection circuit further comprises:
a first temperature detection circuit and a second temperature detection circuit, the plurality of photovoltaic terminals and the converter are respectively disposed on two sides of the PCB, the PCB comprises a first thermally conductive insulation layer and a second thermally conductive insulation layer, the first thermally conductive insulation layer is close to a side of the converter, and the second thermally conductive insulation layer is close to a side of the plurality of photovoltaic terminal.

8. The photovoltaic inverter according to claim 1, further comprising:
a mounting panel, wherein the housing structure is provided with a notch, the converter is disposed inside the housing structure, the mounting panel is provided with through holes for the plurality of photovoltaic terminals to penetrate, and the mounting panel is configured to be mounted on the housing structure and plug the notch.

9. The photovoltaic inverter according to claim 8, wherein sealants or baffle plates are disposed in gaps between the plurality of photovoltaic terminals and the through holes, so that a sealed environment is formed inside the housing structure.

10. The photovoltaic inverter according to claim 1, wherein each photovoltaic terminal of the plurality of photovoltaic terminals further comprises:
a board-end terminal, wherein a channel that penetrates through two ends of the board-end terminal is provided in the board-end terminal;
a cable-end terminal, wherein a channel that penetrates through two ends of the cable-end terminal is provided in the cable-end terminal;
a first electrically conductive core slidably disposed in the channel of the board-end terminal;
a second electrically conductive core slidably disposed in the channel of the cable-end terminal;
a first electrically conductive cable, wherein a first end of the first electrically conductive cable is crimped on the first electrically conductive core and a second end of the first electrically conductive cable is soldered on the PCB; and
a second electrically conductive cable slidably disposed in the channel of the cable-end terminal, wherein a first end of the second electrically conductive cable is crimped on the second electrically conductive core and a second end of the second electrically conductive cable is connected to the photovoltaic module.

11. The photovoltaic inverter according to claim 10, wherein the photovoltaic inverter further comprises:
a terminal plug-in temperature detection circuit disposed at a plug-in position between the board-end terminal and the cable-end terminal in the photovoltaic terminal and configured to detect a temperature at the plug-in position of the photovoltaic terminal.

12. The photovoltaic inverter according to claim 1, wherein the thermally conductive insulation layer is embedded in the PCB and disposed between the temperature detection circuit the connection joint, at which one of the photovoltaic terminals is connected to the PCB.

13. A temperature detection apparatus, applied to a photovoltaic inverter comprising a plurality of photovoltaic terminals respectively connected to a plurality of photovoltaic modules and a converter, wherein the temperature detection apparatus comprises:
a printed circuit board (PCB) comprising an electrically conductive layer configured to transmit electric energy generated by the plurality of photovoltaic modules to the converter and a thermally conductive insulation layer, wherein one end of each photovoltaic terminal is connected to the PCB;
a temperature detection circuit configured to detect a temperature of the thermally conductive insulation layer, wherein the thermally conductive insulation layer is configured to conduct heat generated by at least one photovoltaic terminal to the temperature detection circuit; and
a controller.

14. The temperature detection apparatus according to claim 13, wherein the thermally conductive insulation layer is embedded in the PCB and disposed between the temperature detection circuit and a connection joint at which at least one of the photovoltaic terminals is connected to the PCB.

15. A photovoltaic inverter comprising:
a printed circuit board (PCB) comprising an electrically conductive layer and a thermally conductive insulation layer;
a housing structure;
a plurality of photovoltaic terminals penetrating the housing structure and having first ends inside the housing structure configured to be electrically connected to the PCB and second ends outside the housing structure configured to be connected to a plurality of photovoltaic modules;
a converter, wherein the electrically conductive layer of the PCB is configured to transmit electric energy generated by the plurality of photovoltaic modules to the converter;
a temperature detection circuit configured to detect a temperature of the thermally conductive insulation layer, wherein the thermally conductive insulation layer is embedded in the PCB and disposed between the temperature detection circuit and a connection joint at which one of the photovoltaic terminals is connected to the PCB; and
the converter and the PCB are disposed inside the housing structure.

16. The photovoltaic inverter according to claim 15, wherein, between one of the plurality of photovoltaic terminals and the temperature detection circuit, the PCB comprises a thermally conductive path including the thermally conductive insulation layer and a connection joint, at which the one of the plurality of photovoltaic terminal is connected to the PCB.

17. The photovoltaic inverter according to claim 15, further comprising:
a controller configured to detect a temperature of at least one of the photovoltaic terminals based on the temperature of the thermally conductive insulation layer.

18. The photovoltaic inverter of claim 6, wherein an upper surface and a lower surface of the thermally conductive layer are separately laminated with the insulation layer and the insulation layer coats and is attached to the laminated thermally conductive layer.

19. The photovoltaic inverter of claim 6, wherein the first temperature detection circuit is configured to detect a temperature of the first thermally conductive insulation layer, the second temperature detection circuit is configured to detect a temperature of the second thermally conductive insulation layer; and the controller is configured to obtain the temperature of each of the plurality of photovoltaic terminals based on the temperatures of the first thermally conductive insulation layer and the second thermally conductive insulation layer.

20. The photovoltaic inverter of claim 10, wherein, after the board-end terminal is connected to the cable-end terminal, the first electrically conductive core establishes an electrical connection to the second electrically conductive core so that a current output by the photovoltaic module is input to the converter by using the photovoltaic terminal.
